(19) United States
(12) Patent Application Publication
(10) Pub. No.: US 2012/0086411 A1
(43) Pub. Date: Apr. 12, 2012

(54) Switching Power Supply Circuit with Reduced Total Harmonic Distortion

(75) Inventor: Laszlo A. Takacs, Lakewood, OH (US)

(73) Assignee: ENERGY FOCUS, INC., Solon, OH (US)

(21) Appl. No.: 13/271,092

(22) Filed: Oct. 11, 2011

Related U.S. Application Data
(60) Provisional application No. 61/391,403, filed on Oct. 8, 2010.

(51) Int. Cl. G05F 1/70

(52) U.S. Cl. 323/205

(57) ABSTRACT

A switching power supply circuit has a control circuit for current-mode on-off control of a primary switch connected to an inductor in a voltage boost topology for operation in boundary-conduction mode. The time at which the primary switch is opened is determined by magnitude of current flowing through the primary switch together with the instantaneous voltage present on an AC input to the power supply circuit. The time at which the primary switch is closed is determined by demagnetization of the inductor. An improvement to the foregoing switching power supply circuit comprises a maximum-on-time enforcement circuit to limit the maximum possible primary switch on-time to a predetermined maximum period of time. The enforcement circuit provides a signal to the control circuit to cause termination of the primary switch on-state if and only if the primary switch has been turned on for more than the predetermined maximum period of time.

### CROSS-REFERENCE TO RELATED APPLICATION

The present application claims priority from U.S. Provisional Patent Application No. 61/391,403 filed October 8, 2010, the entirety of which is incorporated herein by reference.

### FIELD OF THE INVENTION

The present invention relates to a switching power supply circuit having an inductor operating in boundary-conduction mode and exhibiting reduced total harmonic distortion.

### BACKGROUND OF THE INVENTION

There are many possible operating modes for switching power supply circuits incorporating power factor correction. One popular mode is the so-called Boundary Conduction Mode (BCM) operating in current-mode control. In the Boundary Conduction Mode (BCM), a primary boost inductor is energized to twice the average current draw and then allowed to fully demagnetize before being immediately re-energized. The current drawn from the AC input source is a variable-frequency sawtooth wave whose average value is controlled to follow the mains voltage. Furthermore, in the current-mode control, the main switch turns on until a preset current value is reached. The switch is then opened until the current through the inductor falls to zero. The switch is then closed and the cycle repeats. The current limit where the switch is opened follows the line voltage and in this way the average current is a mirror image of the voltage waveform.

Total harmonic distortion (THD) is a function of the qualitative, and in fact quantitative, difference between the AC input current and voltage waveforms. When switching power supply circuits using power factor control (PFC) are connected to ideal voltage sources, very low THD levels, e.g., below 1%, can be achieved in the laboratory and in computer simulations. However, these levels are not achieved when the input power is very low, typically 20 Watts or less. There is a tiny but consistent distortion in the current draw near the zero-crossings of the current waveform. In this area, PFC circuitry directs the power conversion stage of a switching power supply circuit to draw very little current since the voltage is low. This low current means that very little energy is stored in the above-mentioned inductor itself. When this low energy is released, when the main switch opens, it is only enough energy to charge the parasitic capacitances inherent in the circuit elements. When this occurs, there is no net transfer of power from input to output. The input current to the circuit will flatline or be reactive in nature against the voltage waveform. This deviation from the required current waveform results in a small amount of THD when the net conversion power is high, e.g., above 100 Watts. When the net input power is very low, e.g., less than about 10 Watts, the small current distortion becomes a more significant fraction of the total power and the THD increases. Some methods for reducing THD are described in the prior art, but none of them result in THD being less than 5% at low power levels.

Therefore, a need exists in switching power supply circuits having an inductor and operating in Boundary Conduction Mode (BCM) with current-mode control to reduce total harmonic distortion.

### BRIEF SUMMARY OF THE INVENTION

A preferred embodiment of the present invention relates to a switching power supply circuit having a control circuit for current-mode on-off control of a primary switch connected to an inductor in a voltage boost topology for operation in boundary-conduction mode. The time at which the primary switch is opened is determined by magnitude of current flowing through the primary switch together with the instantaneous voltage present on an AC input to the power supply circuit. The time at which the primary switch is closed is determined by demagnetization of the inductor. An improvement to the foregoing switching power supply circuit comprises a maximum-on-time enforcement circuit to limit the maximum possible primary switch on-time to a predetermined maximum period of time. The enforcement circuit provides a signal to the control circuit to cause termination of the primary switch on-state if and only if the primary switch has been turned on for more than the predetermined maximum period of time.

The foregoing switching power supply circuit having an inductor and operating in Boundary Conduction Mode (BCM) with current-mode control beneficially reduces total harmonic distortion in the AC line current.

### BRIEF DESCRIPTION OF THE DRAWINGS

Further features and advantages of the invention will become apparent from reading the following detailed description in conjunction with the following drawings, in which like reference numbers refer to like parts:

FIG. 1 is a schematic diagram of a prior art switching power supply circuit, partly in block form.

FIGS. 2-4 are progressively enlarged graphs showing AC INPUT CURRENT, MOSFET CURRENT and MOSFET CONTROL SIGNAL versus time showing a flaw of a prior art circuit, as discovered by the present inventor, with the area of FIG. 3 represented in FIG. 2, and the area of FIG. 4 represented in FIG. 3.

FIG. 5 is similar to FIG. 1, but shows additional circuitry for overcoming a flaw in prior art circuits.

FIGS. 6-8 are similar to FIGS. 2-4, are progressively shrunken graphs showing circuit operation in the presence of an inventive maximum on-time enforcement circuit, with the area of FIG. 6 represented in FIG. 7, and the area of FIG. 7 represented in FIG. 8.

### DETAILED DESCRIPTION OF THE PREFERRED EMBODIMENT

A list of reference numerals and associated parts appears near the end of this detailed description

In order to provide a context in which the present invention operates, a prior art switching power supply circuit is first described.

### Prior Art Switching Power Supply Circuit

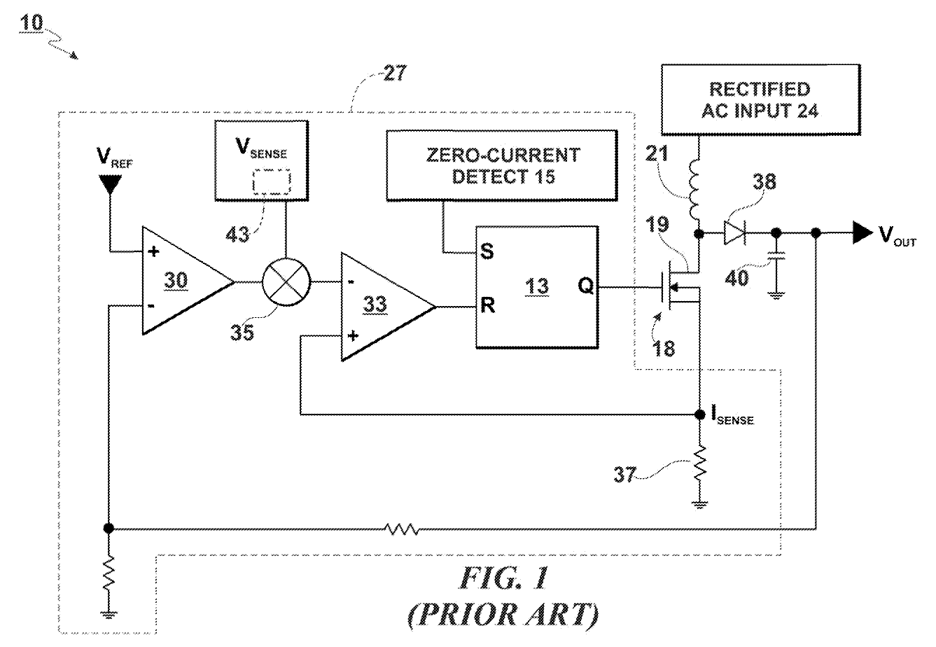

FIG. 1 illustrates a switching power supply circuit 10 in accordance with the prior art. A set-reset (SR) flip-flop 13 is triggered by zero-current detect module 15 to activate, or switch into an “on” state, a power MOSFET switch 18 when the current through inductor 21, powered from a rectified AC input 24, is zero. This can be accomplished by, for example, either monitoring a simple auxiliary winding (not shown) around inductor 21 or by examining the voltage on MOSFET drain 19 The voltage at the MOSFET drain 19 will drop abruptly when the inductor 21 has demagnetized, as will the voltage on the mentioned simple winding. Once SR flip-flop 13 is set, the Q output turns on power switch 18 and the current through inductor 21 begins a linear ramp upward.

As will be routine to those of ordinary skill in the art based on the present specification, power MOSFET switch 18 may be alternatively embodied as a bipolar transistor or other type of power switch.

In the switching power supply circuit 10 of FIG. 1, a control circuit 27 for the power MOSFET switch 18 determines the appropriate current through the inductor 21 at which to turn off the MOSFET switch 18 by utilizing op-amps 30 and 33 and a multiplier 35. In the present embodiment, the left-shown op-amp 30 is configured as an error amplifier. It measures the difference between a desired reference voltage, V_{REF}, and actual output voltage V_{OUT}. The error signal supplied by op-amp 30 to multiplier 35 is a measure of how far the output voltage V_{OUT} deviates from a desired control point. This error signal is multiplied together with a sinusoidal voltage sample V_{SENSE} of an AC input waveform (not shown), by multiplier 35, and sent to op-amp 33, configured as a comparator, which is shown in FIG. 1 as driving the Reset (R) input to flip-flop 13. At any given instant of time, the output of the multiplier 35 represents the amount of current which should be drawn through inductor 21 in order for the circuit 10 to provide power-factor correction. The output of multiplier 35 is compared to the actual current flowing through the MOSFET switch 18 and inductor 21, via sensing of current at the I_{SENSE} node by sensing voltage on a resistor 37. The other, unnumbered resistors in control circuit 27 are used for routine feedback purposes that will be apparent to persons of ordinary skill in the art based on the present specification.

Once the current flowing through inductor 21 reaches the same level as indicated by the output of multiplier 35, comparator 33 outputs a signal which resets flip-flop 13, thus turning off switch 18. This is the essence of current-mode control. When switch 18 is turned off, the current through inductor 21 steadily decreases as it passes through a p-n diode 38 or other switch and a capacitor 40, whose voltage is the output voltage V_{OUT}. Once the current through inductor 21 reaches zero, the zero-current detect module 15 reactivates (i.e., turns on) switch 18 and the cycle is complete.

At each switching cycle, there is a small amount of energy that is stored in the natural capacitances inherent in the power MOSFET switch 18, diode 38 and other components (not shown). These natural capacitances often are called parasitic capacitances. The effect of the parasitic capacitances near the zero crossings of the AC input (not shown) is to prevent the transfer of current from the rectified AC input 24 to the output V_{OUT} because the energy in the parasitic capacitances is switched instead. The technology of U.S. Pat. No. 6,984,963 B2 attempts to solve this problem by prolonging the on-time of a power switch near the zero crossings of the AC input (not shown). This helps to restore the necessary energy transfer from input to output for reducing crossover distortion near the AC input zero crossings, but the present inventor has discovered a deficiency in such prior art approach.

### Flaw in a Prior Art Approach

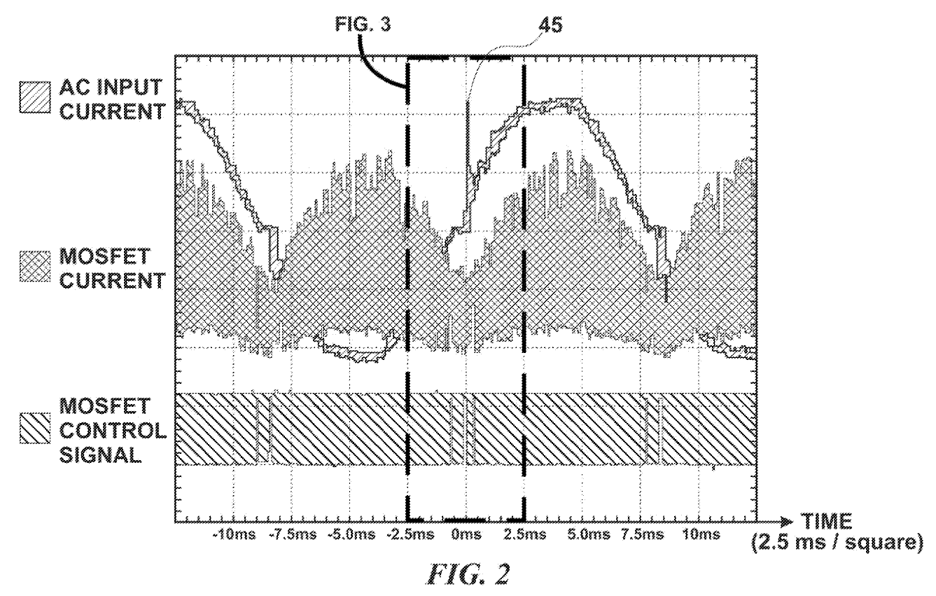

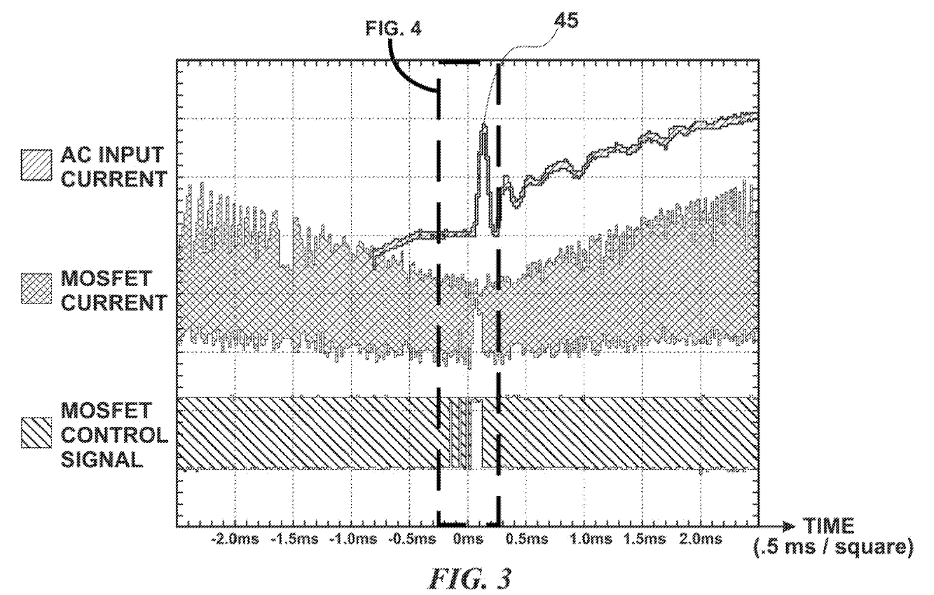

In particular, the foregoing U.S. Pat. No. 6,984,963 B2 teaches the addition to the switching power supply circuit 10 of FIG. 1 of a prolongation circuit 43. Very close to zero crossings of the AC input, prolongation circuit 43 causes the switch-off current threshold, which is the output of comparator 33 provided to RS flip-flop 13 as the Reset (R) input, to be increased. As discovered by the present inventor, if the switch-off current threshold is increased too much, there will not be enough voltage present to force sufficient current through inductor 21 to meet the switch-off threshold. As illustrated in FIGS. 2-4, this will cause MOSFET switch 18 to stay on for a relatively extended period of time and create an undesirable current spike 45 in the AC input current when the MOSFET switch begins switching again as the AC input current moves away from its zero crossings. FIGS. 2-4 show progressively enlarged graphs of AC INPUT CURRENT, the current through MOSFET switch 18 labeled MOSFET CURRENT and the MOSFET CONTROL SIGNAL, or Q output of flip-flop 13. Various of these waveforms are shown as patterned, according to the legends near the vertical axes, instead of showing actual waveforms, since the resolution of such waveforms is too small to show the actual waveforms. However, near the zero crossings of AC INPUT CURRENT, some actual waveforms can be discerned, such as for the MOSFET CONTROL SIGNAL in FIG. 2.

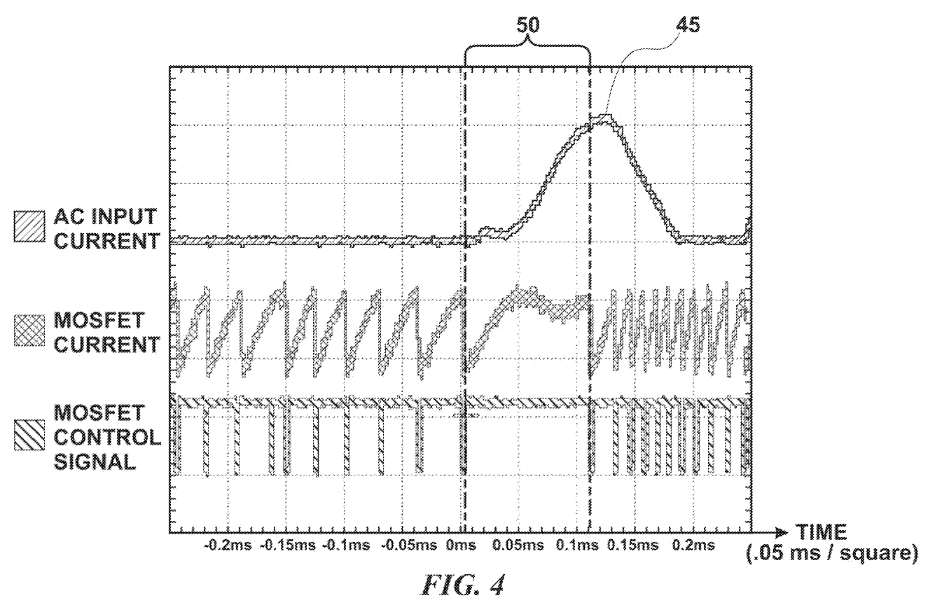

In FIGS. 2-4, AC INPUT CURRENT may be a 60 Hz input current from an AC power line that supplies rectified AC input 24 in FIG. 1. It is mostly a sine wave. The onset of sharp current spike 45 of current at the center of FIGS. 2-4, where the zero-crossing of AC INPUT CURRENT occurs, is problematic, because it causes electrical noise to be transmitted into the AC power line (not shown). Although in FIG. 2, it is difficult to see the MOSFET CURRENT staying on during AC input zero crossings, FIG. 4 in particular shows MOSFET on period 50 and the corresponding MOSFET CONTROL SIGNAL being high during this period. The current spike 45 can be clearly seen arising during MOSFET on period 50 in FIG. 4.

In more detail, as shown in FIG. 4, the MOSFET CONTROL SIGNAL is running at approximately 40 kHz to the left of MOSFET on period 50 where it has commanded the MOSFET switch 18 (FIG. 1) to turn on and stay on for about 106 μs. A period of 106 μs corresponds to a switching frequency of 9.4 kHz. This means that the frequency at the zero crossing abruptly drops from about 40 kHz to about 9.4 kHz. This abrupt drop in frequency contributes to formation the current spike 45 in the AC INPUT CURRENT. To the right of MOSFET on period 50, the MOSFET switch 18 begins switching again at the somewhat higher frequency of about 100 kHz. The precise frequencies that surround MOSFET on period 50 where MOSFET switching has stopped for about 106 μs, as well as the precise duration of the about 106 μs pause, are a function of the circuit design and may vary between designs.

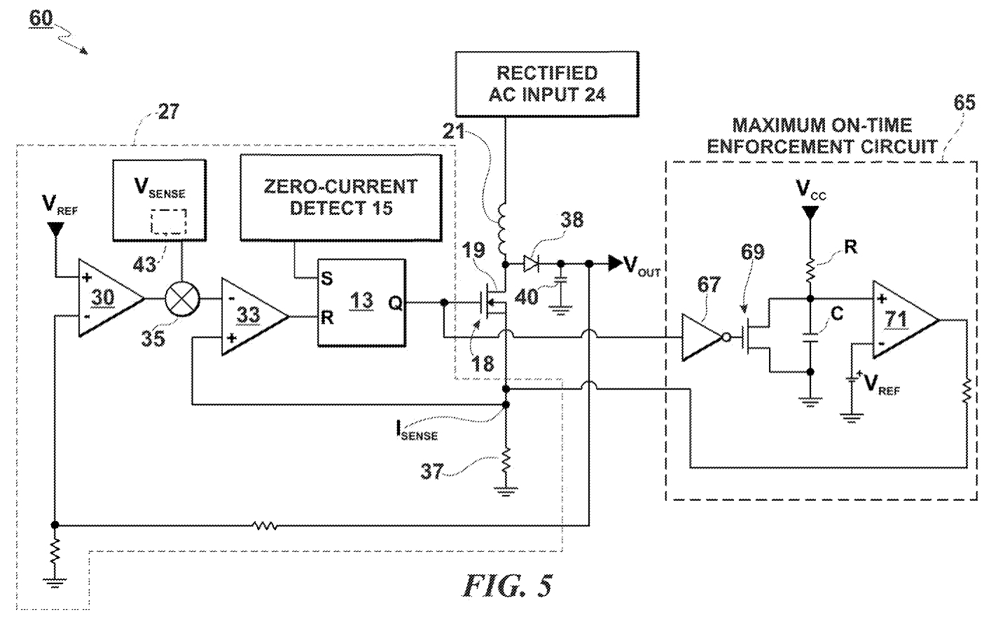

Although prolonged MOSFET on period 50 of FIG. 5 can result from using the prolongation circuit of FIG. 1, an undesirably long MOSFET on period may also result from switching power supply circuit that do not incorporate such a prolongation circuit.

### Maximum On-time Enforcement Circuit

To overcome the foregoing described flaw in prior art switching power supply circuits, especially those incorporating the prolongation circuit 50 of FIG. 1, the inventive switching power supply circuit 60 of FIG. 5 incorporates circuitry to force the MOSFET switch 18 to turn off even though it has not reached the threshold for being shut off by control circuit 27 (FIG. 1). Common reference numerals as between FIGS. 1 and 5 refer to like parts, whose description is therefore omitted in this description of FIG. 5.

In FIG. 5, the added circuitry to force shut-off of MOSFET switch 18 constitutes the maximum on-time enforcement circuit 65. In brief, circuit 65 works by presenting a voltage signal at the I_{SENSE} node, which mimics a proper threshold voltage in the control circuit 27. When control circuit 27 sees this signal generated by the maximum off-time enforcement circuit 65, it will cause a forced turn off of MOSFET switch 18.

The operation of the maximum on-time enforcement circuit 65 is somewhat akin to that of a dead-man switch on a railroad locomotive. In the cab of the locomotive, there is a switch which the engineer must periodically actuate. If the engineer were to become incapacitated and cease actuating the dead-man switch, the locomotive will automatically come to a stop. In a similar manner, if the power MOSFET switch 18 ceases to turn off within a preset maximum period of time, the maximum on-time enforcement circuit 65 will become operative and force the control circuit 27 to turn the power MOSFET switch 18 off.

In the maximum on-time enforcement circuit 65 (FIG. 5), a NAND circuit 67 receives an input from the Q output of RS flip-flop 13, and applies an output to field-effect transistor 69, whose source and drain are connected across a capacitor C. Capacitor C is charged through a resistor R by a supply voltage, V_{CC}, and has a charging time-constant determined by RC. Each time control circuit 27 turns power MOSFET switch 18 off, capacitor C is discharged. As long as there are frequent off-cycles, the charge on capacitor C cannot build up. When the MOSFET switch 18 is turned on, capacitor C is allowed to charge through resistor R If the voltage across capacitor C reaches the V_{REF} threshold of control circuit 27 after a time determined by RC, then op-amp comparator 67 will trigger, thus forcing the I_{SENSE} line to have an elevated voltage signal so as to turn off the MOSFET switch 18.

As long as on-time of power MOSFET switch 18 does not exceed a maximum period of time determined by the RC time constant, the output of the maximum on-time enforcement circuit 65 will remain in a low state. If the on-time of the MOSFET switch 18 is longer than the time determined by the RC time constant, then and only then, the output of maximum on-time enforcement circuit 65 will become operative to force the control circuit 27 to turn the power MOSFET switch 18 off.

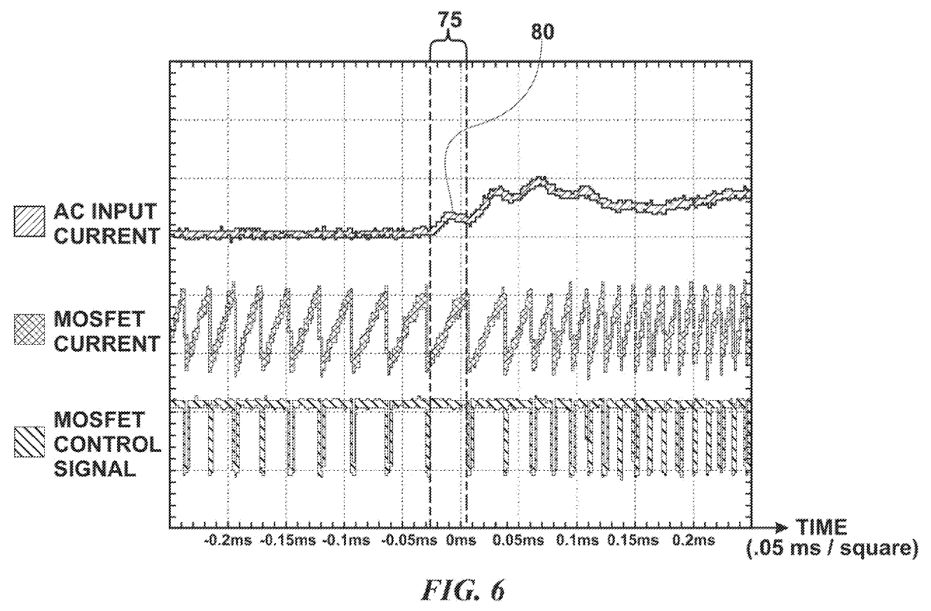

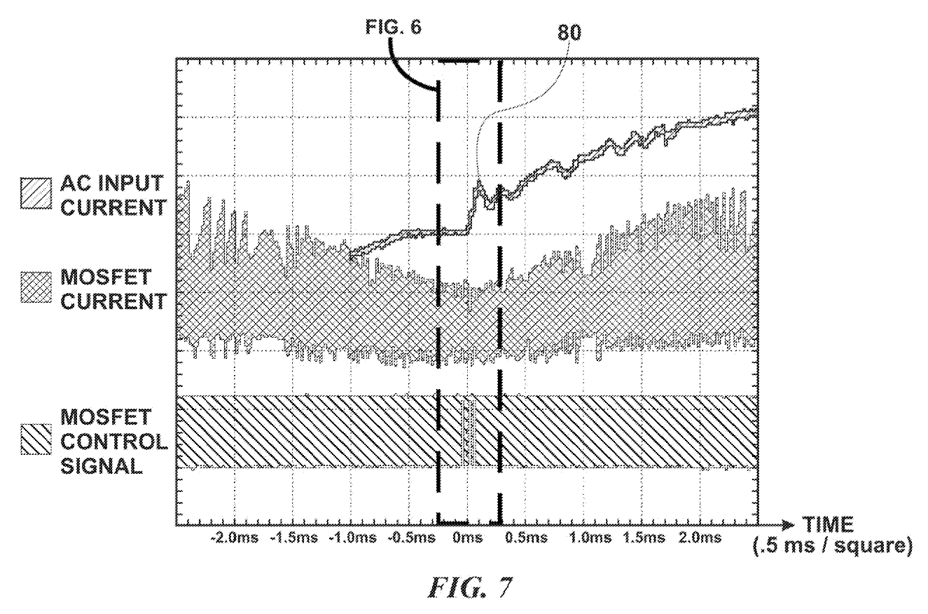

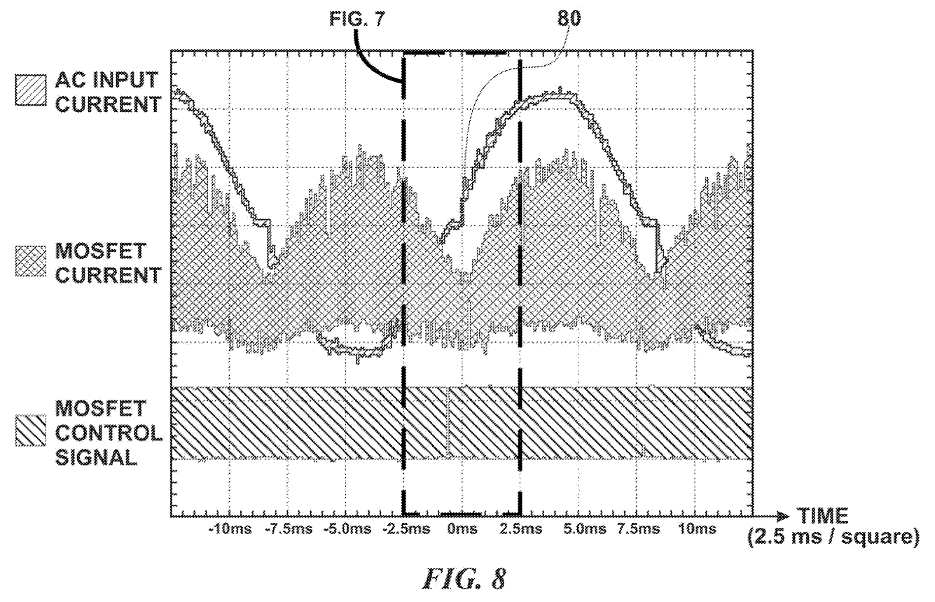

The operation of maximum on-time enforcement circuit 65 is illustrated in the progressively shrunken graphs of FIGS. 6-8. FIG. 6 has the same time scale as FIG. 4, but shows a considerably shorter MOSFET on period 75 compared with MOSFET on period 50 of FIG. 4. In particular, for a specific circuit configuration, the MOSFET on period 75 may be no larger than about 30 μs, compared with the considerably longer MOSFET on period 50 of FIG. 4. As can be appreciated from the graphs of FIGS. 6-8, the magnitude of a current spike 80 is reduced to about half of the current spike 45 of FIGS. 2-4, which beneficially reduces total harmonic distortion.

The following is a list of reference numerals and associated parts as used in this specification and drawings:

| Reference | |
|---|---|
| Numeral | Part |
| 10 | Switching power supply circuit |
| 13 | SR flip-flop |
| 15 | Zero-current detect module |
| 18 | Power MOSFET switch |
| 19 | Drain |
| 21 | Inductor |
| 24 | Rectified AC input |
| 27 | Control circuit |
| 30 | Op-amp or error amplifier |
| 33 | Op-amp or comparator |
| 35 | Multiplier |
| 37 | Resistor |
| 38 | P-n diode |
| 40 | Capacitor |
| 43 | Prolongation circuit |
| 45 | Current spike |
| 50 | MOSFET on period |
| 60 | Switching power supply circuit |
| 65 | Maximum on-time enforcement circuit |
| 67 | NAND circuit |
| 69 | Field-effect transistor |
| 71 | Op-amp comparator |
| 75 | MOSFET on period |
| 80 | Current spike |

While the invention has been described with respect to specific embodiments by way of illustration, many modifications and changes will occur to those skilled in the art. For instance, various electrical components or functions may be contained in an integrated circuit, as will be routine to persons of ordinary skill. It is, therefore, to be understood that the appended claims are intended to cover all such modifications and changes as fall within the true scope and spirit of the invention.

What is claimed is:

1. In combination with a switching power supply circuit having a control circuit for current-mode on-off control of a primary switch connected to an inductor in a voltage boost topology for operation in boundary-conduction mode, wherein the time at which the primary switch is opened is determined by magnitude of current flowing through the primary switch together with the instantaneous voltage present on an AC input to the power supply circuit, and wherein the time at which the primary switch is closed is determined by demagnetization of the inductor; the improvement comprising:
a maximum-on-time enforcement circuit to limit the maximum possible primary switch on-time to a predetermined maximum period of time; said enforcement circuit providing a signal to the control circuit to cause termination of the primary switch on-state if and only if the primary switch has been turned on for more than said predetermined maximum period of time.

2. The combination of claim 1, wherein:
a) the control circuit causes a prolongation circuit for prolonging of the primary switch on-time in the vicinity of zero-crossings of the AC input to reduce input current distortion by increasing a turn-off threshold current of the primary switch; and
b) the maximum-on-time enforcement circuit overrides the prolongation circuit if the primary switch has been turned on for more than said predetermined maximum period of time.

3. The combination of claim 2, wherein the overriding of the prolongation circuit by the maximum-on-time enforcement circuit occurs by the maximum-on-time enforcement circuit creating an artificial turn-off signal current which exceeds the threshold current otherwise set by the control circuit.
